(19) United States
(12) Patent Application Publication
(10) Pub. No.: US 2009/0160621 A1
(43) Pub. Date: Jun. 25, 2009

(54) MULTIMEDIA ARTICLE MANAGEMENT FACILITY

(75) Inventors: Marco Canu, Rome (IT); Sandro Piccinini, Rome (IT); Luigi Pichetti, Rome (IT); Marco Secchi, Rome (IT)

Correspondence Address: IBM CORP. (AUSTIN), C/O NELSON AND NELSON, 2984 E. EVERGREEN AVE., SALT LAKE CITY, UT, 84109, US

(73) Assignee: INTERNATIONAL BUSINESS MACHINES CORPORATION, Armonk, NY (US)

(21) Appl. No.: 12/250,319

(22) Filed: Oct. 13, 2008

(30) Foreign Application Priority Data
Dec. 19, 2007 (EP) EP07123601

(51) Int. Cl. H04Q 5/22

(52) U.S. Cl. 340/10.5

(57) ABSTRACT

A method is presented for managing user preferences upon reading a multimedia article. The method may include receiving a request to read the multimedia article, and reading a RFID tag coupled to the multimedia article. The RFID tag may store user preference information for reading the multimedia article. The user preference information may then be applied, and the multimedia article may be read in accordance with the user preference information.

### BACKGROUND OF THE INVENTION

### Description of the Related Art

Multimedia storage articles, such as compact disks (“CD”) and digital video disks (“DVD”), are increasingly used to store information like music, movies, photographs, and the like. Users of such storage articles often desire to organize or customize the information stored thereon. For example, some users customarily create play lists of music. Other users like to rearrange scenes or customize movie options prior to watching a movie. Presently, such customization information must be re-entered each time a multimedia storage article is read. Users desiring to watch a specific film in a specific language, with specific subtitles and video formatting, for example, must re-enter this information each time the movie is watched.

### SUMMARY OF THE INVENTION

Embodiments of the invention provide multimedia article management tools and facilities.

Some embodiments of the invention include a method for managing user preferences upon reading a multimedia article. The method may include receiving a request to read the multimedia article, and reading a RFID tag coupled to the multimedia article. The RFID tag may store user preference information for reading the multimedia article. The user preference information may then be applied, and the multimedia article may be read in accordance with the user preference information.

A corresponding system for implementing the above-stated method is also disclosed and claimed herein.

### BRIEF DESCRIPTION OF THE DRAWINGS

In order that the advantages of the disclosure will be readily understood, a more particular description of embodiments of the invention briefly described above will be rendered by reference to specific embodiments illustrated in the appended drawings. Understanding that these drawings depict only typical embodiments of the invention and are not therefore to be considered limiting of its scope, embodiments of the invention will be described and explained with additional specificity and detail through use of the accompanying drawings, in which:

FIG. 1 depicts an environment in which embodiments of the invention may be implemented;

FIG. 2 illustrates one embodiment of a system for managing user preferences with respect to a multimedia article in accordance with the invention;

FIG. 3 details features of a system for managing user preferences in accordance with certain embodiments of the invention;

FIG. 4 is a sequence diagram detailing a method for managing user preferences in accordance with one embodiment of the invention;

FIG. 5 is a flow chart of a method for managing user preferences in accordance with certain embodiments of the invention.

### DETAILED DESCRIPTION OF THE INVENTION

It will be readily understood that the components of embodiments of the present invention, as generally described and illustrated in the Figures herein, may be arranged and designed in a wide variety of different configurations. Thus, the following more detailed description of the embodiments of the systems and methods of the present invention, as represented in the Figures, is not intended to limit the scope of the disclosure, as claimed, but is merely representative of selected embodiments of the invention.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that embodiments of the invention can be practiced without one or more of the specific details, or with other methods, components, etc. In other instances, well-known structures, or operations are not shown or described in detail to avoid obscuring aspects of the disclosure.

The illustrated embodiments of the invention will be best understood by reference to the drawings, wherein like parts are designated by like numerals throughout. The following description is intended only by way of example, and simply illustrates certain selected embodiments of the invention that are consistent with the disclosure as claimed herein.

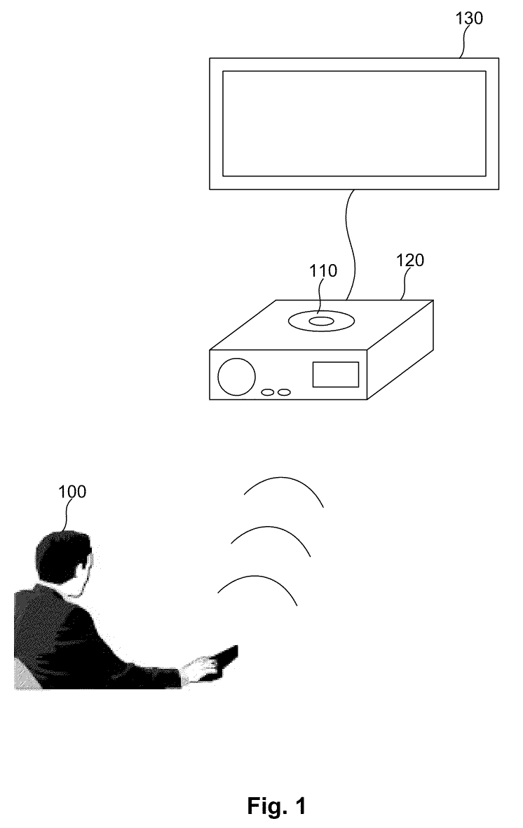

FIG. 1 illustrates a system environment in which embodiments of the invention may be implemented. A medium article 110, such as a CD, DVD or the like, may store multimedia data read by a media player 120. A user 100 may enter user preferences for reading the data of the medium article 110 by remote control, for example, or as required by the media player 120. The media player 120 may display a dialog 130 or may allow use of specific function keys on a remote control or control panel of the media player to set user preferences.

A media player 120 may include a user interface which may vary according to the type of media player 120. For example, a movie-type media player may communicate with the user through a screen 130, a remote control, and/or a control panel. In another embodiment, the user may define a music play list using functions keys of a remote control. In still other embodiments, the user may rearrange movie scenes or select a language for playing the movie. User preferences may be immediately accessed and used by the media player 120 to set corresponding parameters for reading the data.

In prior art systems, user preferences must be re-entered each time a particular medium is read. Further, user preferences are typically lost when the medium article is changed, or when the multimedia player is shut down. It is possible to store some settings in the media player, like brightness or video format, as default settings. However, such settings are neither specific to the media article, nor to the individual files stored on thereon.

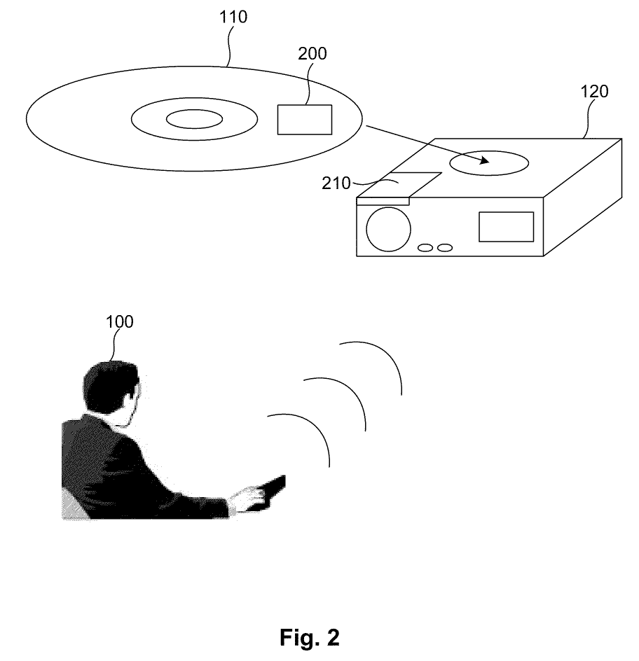

FIG. 2 illustrates one embodiment of a system for managing user preferences with respect to a multimedia article in accordance with the invention. As illustrated, the system may include a R/W RFID tag 200 coupled to the multimedia article that locally stores the desired medium configuration. The RFID tag 200 may automatically identify objects stored on the multimedia article 110, and may optionally provide information regarding certain desired attributes or properties. Such RFID tags 200 may be inexpensive to produce, and may enable user preference information to be provided before reading the multimedia article 110. User preference information stored on RFID tags 200 may be wirelessly accessed by way of a radio frequency signal.

The RFID tag 200 may be attached to the unwritten surface of a multimedia article 110, or alternatively, to a support case for the multimedia article 110. This RFID tag 200 may be used to store information regarding user customization and preferences with respect to the multimedia article 110. Each time a user customizes use of the specific multimedia article 110, by creating a play list or rearranging scenes, for example, the multimedia article 110 may be configured to save the customization into the RFID tag 200 for later use.

The media player 120 may include a component 210 able to interact with the RFID tag 200. The component 210 may read the stored configuration, if present, and/or may save new information to the tag 200. This component 210 may interface with the R/WRFID tag 200 to retrieve the user preference information and provide to the media player 120 the information to be stored or updated. The media player 120 may include additional components or enhancements to enable it to communicate with the component 210. In some cases, either or both of the component 210 and the media player 120 may be enhanced with logic implemented mainly in software.

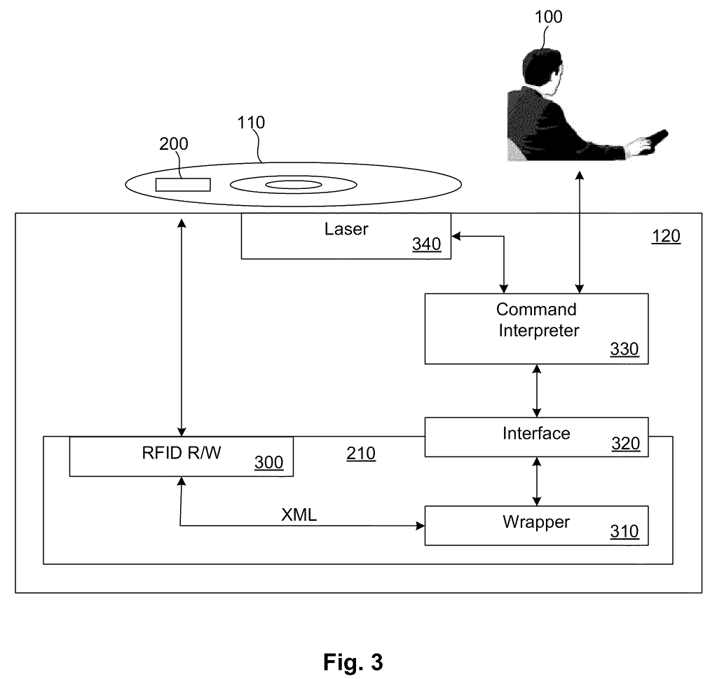

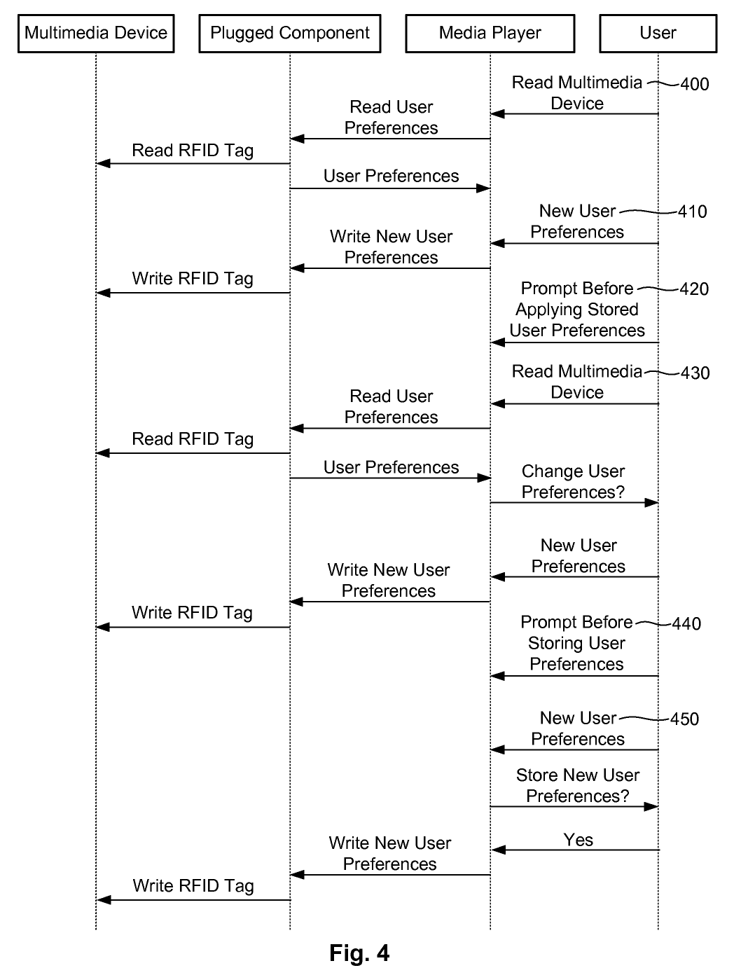

Referring now to FIG. 3, the media player 120 may include a command interpreter 330 to communicate with the user through the remote control or the media player control panel, for example. The command interpreter 330 may be coupled to a laser 340 or other article for reading the multimedia article 110. This command interpreter 330 may include logic for interpreting commands for managing user preferences and for interfacing with a component 210 capable of accessing the RFID tag 200 of the multimedia article 110. Such commands and internal operations are discussed in more detail with reference to FIG. 4 below.

A plugged component 210 may be added to the media player 120 to read and write information from and to the RFID tag 210. The plugged component 210 may include a wrapper 310 capable of converting multimedia player options into a format able to be stored on the RFID tag 200, for instance in XML. This information may be re-read at the next use of the multimedia article 110. In some embodiments, the wrapper 310 may also convert information read on the RFID tag 200 into another format used by the media player 120 to encode the user preferences.

A RFID read/write article 300 may be used to directly read and write information from and to the RFID tag 200 on the multimedia article 110. The RFID read/write article 300 may transfer and receive information to and from the wrapper 310 via radio frequency. An interface 320 may enable data to be transmitted between the plugged component 210 and the command interpreter 330. The command interpreter 330 may send to the RFID read/write article 300, across the interface 320, internal requests to read or write the RFID tag 200. Such internal requests may include commands and arguments known to those in the art.

It is noted that user preferences stored on the RFID tag 200 may include information that may be understood by the media player 120 and used to set parameters when reading data on the multimedia article 110. In one embodiment, the RFID tag 200 may be written with such information by the media player 120, according to information entered by a user. In this manner, the user preferences stored in the RFID tag 200 may be specific to one user (ie. the owner of the multimedia article), as well as to the particular multimedia article 110. Other embodiments may enable additional information to be stored by the RFID tag 200, including for example, information provided by the multimedia article manufacturer.

FIG. 4 illustrates one embodiment of a method for managing user preferences for reading a multimedia article. Data exchanged between system components may correspond to operations performed by the media player to manage the user preference information and read the multimedia article.

In certain embodiments, user preference information may be stored in a read/write RFID tag and leveraged as desired. The preferences may be stored in the RFID tag in a predefined format such that a pluggable component of a media player may read and convert the RFID tag information into user preference data provided to the media player.

When a new multimedia article is read 400, the media player command interpreter may request that the plugged component read the user preference information. The plugged component may read the information from the RFID tag on the multimedia article. Particularly, the plugged component may use the RFID R/W to read the information, and may convert the information into a format expected by the media player. The information, in converted format, may then be forwarded to the media player. In this manner, the media player may receive user preference information, apply the user preferences, and read the multimedia article.

When new user preference information is entered 410, the media player command interpreter may require the plugged component to store the user preference information on the multimedia article. Such user preference information may be provided in response to a request from the media player. The plugged component may encode the user preferences and command the RFID R/W to write the encoded data on the RFID tag. The media player may also apply the user preferences prior to or upon reading the multimedia article. When the same multimedia article is re-read, the media player may be able to retrieve the user preferences previously stored.

In certain embodiments, the user may require a prompt 420 prior to the media player applying the user preferences stored in the RFID tag. In such embodiments, upon reading 430 the multimedia article, the media player may read the user preferences from the RFID tag and query the user for new user preference information. If no new user preference information is entered, the media player may apply the previously-stored user preferences for reading the multimedia article.

If new user preference information is entered 410, the new user preferences may be stored on the RFID tag of the multimedia article. In some embodiments, the user may require a prompt 440 prior to the media player storing new user preference information. New user preference information may thus be stored 450 only in response to an affirmative reply from the user. The media player may then apply the new user preferences for reading the multimedia article.

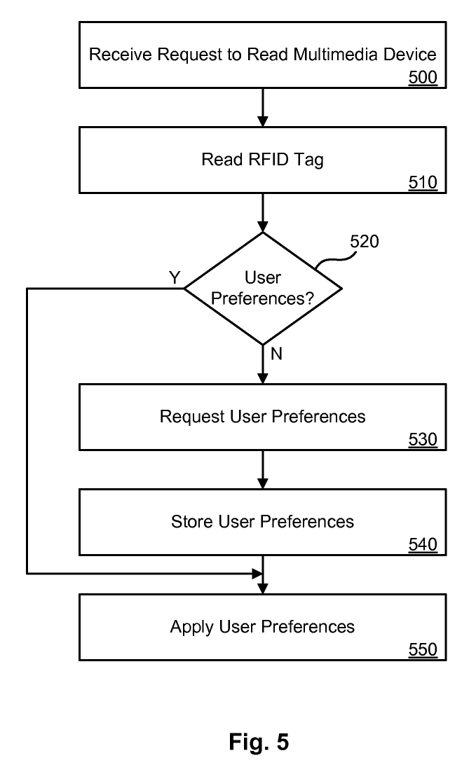

FIG. 5 is a flowchart of a method for managing user preferences for reading a multimedia article in accordance with an embodiment of the invention. In a first step 500, a media player may receive through a user interface a request to read a certain multimedia article. The user interface may include, for example, a remote control, a control panel, a video monitor, or the like. The media player may interface with a plugged component to read 510 RFID tag information from the multimedia article. The plugged component may read the RFID tag information and convert it to a standard format understandable by the media player.

A next step 520 of the method may determine whether any user preference information is present. If no user preference information is found, the media player, through a user interface, may query 530 the user for user preference information for reading the multimedia article. The user may then enter user preference information through the user interface.

The media player may then query the plugged component through an interface to store 540 the user preferences on the RFID tag. The plugged component may convert the user preference information to a format used by the R/W RFID, and transfer the encoded data to the RFID R/W component to store on the RFID tag. The media player may then apply 550 the user preferences for reading the multimedia article.

In some embodiments, the media player may receive a second user request to read the same multimedia article. At times, this may occur after the media player has been switched off, or after reading another multimedia article in the interim. In these cases, the media player may again execute the steps of the method. For example, the mediaplayer may read 510 the previously-stored user preferences from the RFID tag, and then apply 550 them without requiring any further action from the user.

The method of the preferred embodiment may provide a basis for many other embodiments. In such embodiments, additional logic (mostly software-based) may be added to the media player, the wrapper and/or the command interpreter. The functions may be implemented in an integrated architecture, such as an ‘intelligent’ media player that does not split the functions between a ‘command interpreter’ in the media player and a ‘wrapper’ in a common plugged component.

For example, in some embodiments, the RFID tag may store different user preferences information for different users, where each set of user preference information is associated with a particular user. Before fetching the user preferences on the RFID tag, the media player may identify the user using its usual user interface. The user identification, for example a pin code, may be provided to the plugged component through the interface. The ‘read user preferences’ command from the command interpreter to the plugged component may include ‘user id’ as an argument.

In some embodiments, the RFID tag may contain user identifiers and detailed user preferences for each user identifier. The wrapper of the plugged component may be enhanced for selecting among the information stored on the RFID tag. The user preferences associated with the user id may be provided as an argument of the ‘read user preferences’ command. The wrapper may then provide to the media player the selected user preferences via the interface.

In another embodiment, the RFID tag may store different user preference information depending on the type of media player. For instance, ‘CinemaSettings’ user preference information may be stored if the media player is a home cinema, and ‘TravelSettings’ user preference information may be used if the media player is laptop or a compact disk reader. In this case, the media player may store in the RFID tag the user preferences and the associated media player type that is stored in the media player itself. Then, the media player may not immediately apply any user preferences. Instead, after accessing the RFID information, the media player may query the user for user preference information through its usual user interface. The media player may display, for example: “The following customizations are found for the media: ‘CinemaSettings,’ ‘TravelSettings,’ please select which customization you wish to apply.”

In another embodiment, the media player may communicate specific information to the plugged component. Specific information may include, for example, media player model, manufacturer, part number, or the like. The media player may then command the plugged component to read the RFID tag to access the user preference information associated with the media player-specific information. Some user preferences may be used for reading a multimedia article on a specific part number media player, for all media players of certain model, or the like. The media player may then automatically apply the user preferences for reading the multimedia article.

In a further embodiment, the RFID tag may store user preferences per user, where each user is associated with specific customizations triggered by the type of media player.

In another embodiment, the multimedia article manufacturer may store in the RFID tag of the multimedia article a article category, such as music CD, DVD movie, data CD, or the like. The media player may collect statistical information regarding user preferences applied for each article category. Such information may be presented to the user or automatically applied for reading the multimedia article by default when no other customization is found in the RFID tag.

For example, the statistical information may reflect that all “thriller” movies are associated with specific user preferences. When the RFID tag indicates that the multimedia article contains a thriller movie and no user preference information is stored in the RFID, the media player may either propose to the user the user preferences generally associated with a thriller movie, or immediately apply the best match configuration reflected by the statistic for such content.

In a further embodiment of the invention, a multimedia support may be equipped with an inexpensive read-only RFID tag. The RFID information may be stored on the RFID tag by the multimedia article manufacturer. Such information may include, for example, media identifier, and media type (rock music, classical music, thriller movie, comedy movie). This information, coupled with default customization information may provide customization by media classification, such as music, movie, or photo, or by media sub-type, such as classic, thriller, or comedy. In one embodiment, the read-only RFID tag may enable a user to change user preference settings temporarily during the reading.

A read-only or read/write RFID tag in accordance with embodiments of the invention may be positioned either on the multimedia itself, or on the multimedia container or case. The RFID tag may be accessed by a media player in accordance with embodiments of the invention. Positioning the RFID tag on the container of the multimedia article may allow use of the same customization for a family of articles, and also for different articles such as tape, micro CD, and the like. The container may contain a target family identifier or target media identifier so that its customization can be applied to a family of multimedia articles or, in some cases, to a single article.

In another embodiment, an RFID tag may be applied externally to the multimedia article. For example, an external RFID tag, such as a sticker, may be affixed to an external surface or container of a multimedia article. In this manner, an existing CD, DVD, or other multimedia article may be retrofitted to include an RFID tag in accordance with embodiments of the invention.

In another embodiment, an RFID tag in accordance with embodiments of the invention may automatically provide to a user a detailed and up-to-date catalogue of multimedia and multimedia articles in the user's possession that may be classified or searched by a descriptive field.

In a further embodiment, the RFID tag may store information regarding user preference information management. For example, the RFID tag may indicate that, for a particular user, the user preferences stored on the RFID tag may be applied automatically by the media player article for reading the multimedia article. Alternatively, the RFID tag may indicate that the user should be prompted prior to the media player applying the user preference information stored on the tag. In certain embodiments, the RFID tag may indicate that the media player should require a password prior to reading the multimedia article.

1. A method for managing user preferences upon reading a multimedia article, the method comprising:
receiving a request to read a multimedia article;
reading a RFID tag coupled to the multimedia article, wherein the RFID tag stores user preference information for reading the multimedia article;
applying the user preference information; and
reading the multimedia article in accordance with the user preference information.

2. The method of claim 1, wherein in the event no user preference information is stored in the RFID tag, additional steps are performed, the steps comprising:
requesting the user preference information;
receiving the user preference information; and
storing the user preference information in the RFID tag.

3. The method of claim 2, further comprising:
receiving a request from the user for a storage prompt;
prompting the user with the storage prompt prior to storing the user preference information; and
storing the user preference information in the RFID tag only upon receiving an affirmative response to the storage prompt.

4. The method of claim 1, further comprising:
receiving user identification information;
associating the user preference information with the user identification information;
storing the user preference information and the associated user identification information in the RFID tag; and
reading from the RFID tag the user preference information and the associated user identification information.

5. The method of claim 1, further comprising:
receiving media player type information;
associating the user preference information with the media player type information;
storing the user preference information and the associated media player type information in the RFID tag; and
reading from the RFID tag the user preference information and the associated media player type information.

6. The method of claim 1, further comprising:
receiving multimedia article data type information;
associating the user preference information with the multimedia article data type information;
storing the user preference information and the associated multimedia article data type information in the RFID tag; and
reading from the RFID tag the user preference information and the associated multimedia article data type information.

7. The method of claim 1, wherein the RFID tag is located on an unwritten surface of the multimedia article.

8. The method of claim 1, wherein the RFID tag is located on a multimedia article container.

9. A system for managing user preferences upon reading a multimedia article, the system comprising:
a command interpreter for receiving a request to read a multimedia article, the multimedia article having a RFID tag coupled thereto, the RFID tag storing user preference information;
a RFID R/W component for reading the user preference information; and
a wrapper communicating with the command interpreter and the RFID R/W component, wherein the wrapper converts the user preference information into a format understandable by the command interpreter and forwards the converted user preference information thereto, thereby enabling the command interpreter to apply the user preference information upon reading the multimedia article.

10. The system of claim 9, wherein the wrapper further converts the user preference information into a format understandable by the RFID R/W component to enable the RFID R/W component to read the user preference information.

11. The system of claim 9, wherein the command interpreter further collects the user preference information from a user.

12. The system of claim 11, wherein the command interpreter further sends to the wrapper a request to store the user preference information.

13. The system of claim 12, wherein the wrapper further converts the user preference information into a format understandable by the RFID R/W component to enable the RFID R/W component to write the user preference information to the RFID tag.

14. The system of claim 13, wherein the RFID R/W component further stores the user preference information in the RFID tag.

15. The system of claim 9, wherein the command interpreter further applies the user preference information upon reading the multimedia article.

16. The system of claim 11, wherein the command interpreter further receives a request to display a prompt prior to storing the user preference information.

17. The system of claim 16, wherein the command interpreter displays the prompt prior to storing the user preference information.

18. The system of claim 17, wherein the command interpreter stores the user preference information only upon receiving an affirmative response to the prompt.
